(19) United States
(12) Patent Application Publication
(10) Pub. No.: US 2016/0350726 A1
(43) Pub. Date: Dec. 1, 2016

(54) VEHICLE MAINTENANCE REMINDERS GENERATED FROM ANALYSIS OF PAYMENT TRANSACTION DATA

(71) Applicant: MasterCard International Incorporated, Purchase, NY (US)

(72) Inventors: Edward Lee, Scarsdale, NY (US); Kenny Unser, Fairfield, CT (US)

(21) Appl. No.: 14/812,337

(22) Filed: Jul. 29, 2015

Related U.S. Application Data
(60) Provisional application No. 62/167,455, filed on May 28, 2015.

(51) Int. Cl. G06Q 10/00

(52) U.S. Cl. CPC G06Q 10/20

(57) ABSTRACT

A method includes analyzing payment account transaction data relevant to a motor vehicle. Based on at least one result of the analysis, an estimate is made concerning a number of miles traveled by the motor vehicle in a period since there was a vehicle maintenance transaction involving the motor vehicle. Based on at least one result of the estimation process, a notification is provided to a user of the motor vehicle concerning a need to obtain maintenance for the motor vehicle.

### CROSS-REFERENCE TO RELATED APPLICATION

This application claims the benefit of U.S. Provisional Patent Application No. 62/167,455 filed on May 28, 2015, the contents of which are hereby incorporated by reference for all purposes.

### BACKGROUND

It is not uncommon for users of motor vehicles to lose track of the timing at which they should bring in their vehicles for routine maintenance. Often the users do not have a regular system for reminding themselves to get vehicle maintenance service and/or there is no paper or computerized record-keeping system to remind them. As a result, maintenance service may be delayed or omitted, and the operating efficiency or even the useful life of the motor vehicle may be adversely affected. In the case of leased motor vehicles, the lessee may fail to comply with his/her motor vehicle maintenance obligations undertaken in connection with the leasing documentation.

The present inventors have recognized an opportunity to apply data analysis techniques to ameliorate the above-noted problems.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system that may be a source of information utilized according to some aspects of this disclosure.

FIG. 2 is a block diagram representation of a vehicle maintenance reminder system provided according to aspects of this disclosure.

FIG. 3 is a block diagram representation of a computer system provided according to aspects of the present disclosure.

FIG. 4 is a block diagram representation of another computer system provided according to aspects of the present invention.

FIG. 5 is a flow chart that illustrates aspects of the present disclosure, including functions that may be performed in the system of FIG. 2.

FIGS. 6 and 7 are flow charts that illustrate aspects of some embodiments of the process illustrated in FIG. 5.

### DETAILED DESCRIPTION

In general, and for the purpose of introducing concepts of embodiments of the present disclosure, users of motor vehicles are enrolled in an automated vehicle maintenance reminder system. The users are holders of payment accounts and use their payment accounts to pay for motor-vehicle-related expenses, including maintenance services and refueling (e.g., purchases of gasoline). The reminder system receives and analyzes payment account system transaction data to track transactions when the users obtain maintenance for the cars, and also tracks fuel purchases by the users. Based on the data relating to fuel purchases, the reminder system may estimate the miles traveled by vehicles since the latest maintenance transaction, and may remind the users that the next maintenance is due, when the data analysis indicates that the vehicle has traveled a certain number of miles. This may provide useful information to the users about desirable times for obtaining vehicle maintenance, and may improve the maintenance, efficiency and economics of ownership for the operation of the vehicles.

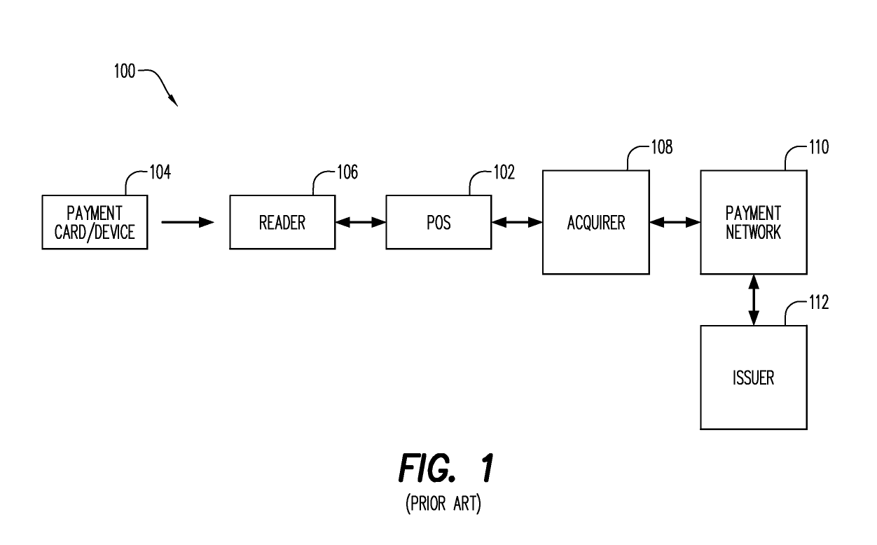

FIG. 1 is a block diagram that illustrates a conventional payment system 100 that may be a source of information utilized according to some aspects of this disclosure. In particular, the representation of the payment system 100 in FIG. 1 reflects the flow of information and messaging for a single payment account transaction.

Thus, the transaction in question may originate at a POS (point of sale) device 102 located in a merchant store (which is not separately indicated). A payment card (or other payment device—e.g., a fob, a payment-enabled smartphone) 104 is shown being presented to a reader component 106 associated with the POS device 102. The reader component 106 may be configured to read payment account data (and/or a payment token) from the payment card/device 104.

A computer 108 operated by an acquirer (acquiring financial institution) is also shown as part of the payment system 100 in FIG. 1. The acquirer computer 108 may operate to receive an authorization request for the transaction from the POS device 102. The acquirer computer 108 may route the authorization request via a payment network 110 to the server computer 112 operated by the issuer of the payment account that is available for access by the payment card/device 104. The authorization response generated by the payment card issuer server computer 112 may be routed back to the POS device 102 via the payment network 110 and the acquirer computer 108.

The payment network 110 may be, for example, the well-known Banknet system operated by MasterCard International Incorporated, which is the assignee hereof

The components of the system 100 as depicted in FIG. 1 are only those that are needed for processing a single transaction. A typical payment system 100 now in use may include a considerable number of payment account issuers and their computers, a considerable number of acquirers and their computers, and numerous merchants and their POS devices and associated reader components. The system may also include a very large number of payment account holders, who carry payment cards and/or other payment-enabled devices.

Of particular relevance to the present disclosure is the fact that the role of POS Terminal 102/reader 106 is, for many transactions, played by a gasoline pump (not shown) at a gasoline station (which is the merchant for the transactions), such that the pump is turned on to permit dispensing of gasoline/diesel fuel in response to the vehicle driver inserting a payment card (or presenting a payment fob) to a payment transaction reader component of the gasoline pump. Of course, it is also the case in some gas stations that an attendant receives the payment card from the user and interfaces the card to a POS terminal/card reader within the gas station building. Where the gas station is also a vehicle repair shop, a card reading transaction as described in the previous sentence may take place in settlement of charges for vehicle maintenance. It is also relevant to note that there are numerous “quick lube” facilities at which oil changes and similar maintenance services are performed for motor vehicles, and that the charges for these services are also commonly settled via a payment card reading transaction at a POS terminal 102/reader 106 located within the “quick lube” facility.

In the course of receiving and relaying the authorization requests and responses, the payment network 110 may receive and store large quantities of transaction data, including, for each one of many transactions, the PAN (primary account number), the date and time of the transaction, the transaction total amount, the merchant name/identifier, a merchant category or type that describes the merchant, and the store location. In some cases, the transaction data may also be indicative of the type of goods or services purchased. This transaction data, referred to above and below as payment network transaction data, may serve—in accordance with aspects of the present disclosure—as the raw material for vehicle mileage travel tracking for generating maintenance reminders.

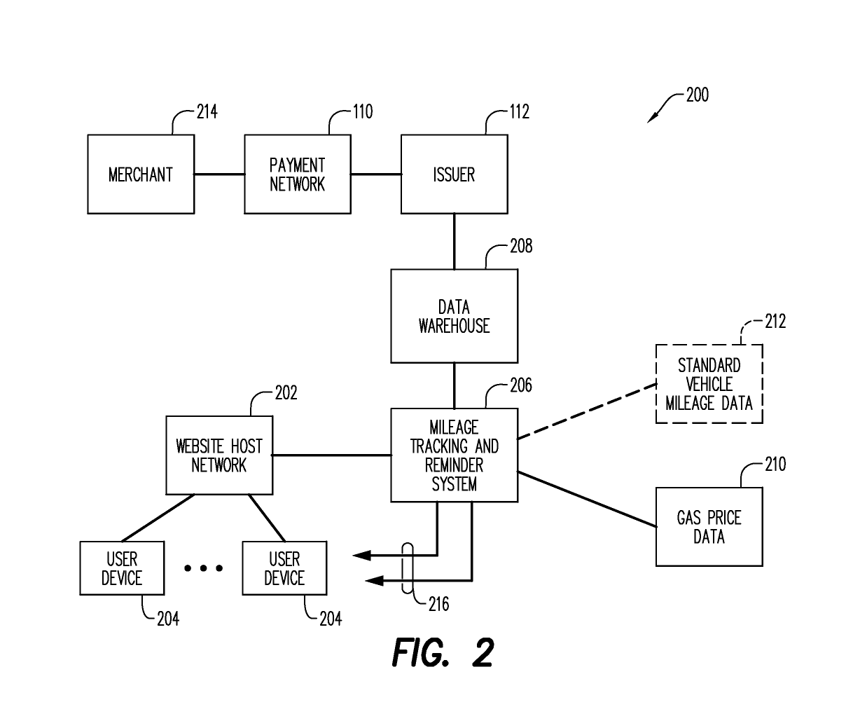

FIG. 2 is a block diagram representation of a vehicle maintenance reminder system 200 provided according to aspects of this disclosure. In FIG. 2, the vehicle maintenance reminder system 200 is depicted largely in functional terms; details of hardware constituting aspects of the vehicle maintenance reminder system 200 will be described below in conjunction with subsequent drawings.

One important element of the vehicle maintenance reminder system 200 is a website host computer 202. The website host computer 202 may host a website that is accessible via the internet. The website may have the function of allowing prospective system users to be enrolled in the vehicle maintenance reminder system 200. Given that the website in question is accessible via the internet, it will be well understood that numerous user devices 204 may be operated by users or prospective users of the website host computer 202 to interact with the website host computer 202. The user devices 204 may be, for example, personal computers running browser programs, or tablet computers or smartphones running mobile browsers. In some embodiments, one or more mobile application programs (“apps”) may be downloadable to mobile devices that serve as user devices 204. Such apps may facilitate the interaction between user devices of that type and the website host computer 202. The interaction between the user devices 204 and the website host computer 202 may be for the purpose of allowing the users of the user devices 204 to enroll in the vehicle maintenance reminder system 200. Enrollment in the vehicle maintenance reminder system 200 may cause the users to receive service from the vehicle maintenance reminder system 200 such that the users are provided with reminders that they should obtain maintenance services for their motor vehicles. Further details of the enrollment process will be described below.

The vehicle maintenance reminder system 200 may include a mileage tracking/reminder computer system 206. The mileage tracking/reminder computer system 206 may be the component of the vehicle maintenance reminder system 200 that provides the reminder service to the enrollees. In this regard, the website host computer 202 may update the mileage tracking/reminder computer system 206 to indicate that individuals have requested to be enrolled in the vehicle maintenance reminder system 200 and have provided enrollment information for that purpose.

The vehicle maintenance reminder system 200 may further include a data warehouse 208 that stores payment account transaction data and makes it available for analysis by the mileage tracking/reminder computer system 206. The payment account transaction data may reflect transactions that were handled in a payment system like that of FIG. 1. Another source of data for the mileage tracking/reminder computer system 206 may be a gas price data source 210, which may (as discussed below) provide the mileage tracking/reminder computer system 206 with information about the price of gasoline on one or more of a regional, local or even gas-station-by-gas-station basis.

In some embodiments, the vehicle maintenance reminder system 200 may include still another source of data for the mileage tracking/reminder computer system 206, namely a standard vehicle mileage data source 212. The latter component may store and make available data that indicates the official fuel economy rating(s) (typically in miles per gallon) for particular vehicles that are identified by make and model. In cases where the mileage tracking/reminder computer system 206 has available to it the make and model of a given user's vehicle, the mileage tracking/reminder computer system 206 may employ the relevant standard/official fuel economy rating (i.e., a fuel consumption characteristic) for the vehicle rather than estimating/inferring that characteristic from payment account transaction data in a manner that will be described below.

Referring again to the data warehouse 208, it should be understood that the payment account transaction data stored therein may have been generated in a payment system similar to the conventional payment system 100 described above in connection with FIG. 1. Accordingly, to illustrate originating components for the payment account transaction data, FIG. 2 also shows payment system components such as an issuer computer 112, a payment network 110, and a merchant 214. As will be readily understood by those who are skilled in the art, the merchant 214 may operate one or more devices (not separately shown in FIG. 2) that correspond to the type or types of POS device 102/reader 106 shown in FIG. 1 and discussed above in connection with that drawing. For purposes of the vehicle maintenance reminder system 200 the relevant types of merchants may be gas stations and vehicle maintenance facilities. In some embodiments, the issuer 112 may sort the payment account transaction data so that only data for transactions with the relevant classes of merchants is provided to the data warehouse 208. In other embodiments, the issuer may “dump” all the transaction data (or all data for enrolled users of the vehicle maintenance reminder system 200) and the data warehouse may discard or outsort the data that is not relevant to the functioning of the reminder system, and may provide only relevant transaction data to the mileage tracking/reminder computer system 206. In some embodiments, the payment network 110 may transmit the transaction data to the data warehouse 208 with respect to at least some of the relevant (or also irrelevant) transactions, instead of or in addition to the data supplied by the issuer 112. In some embodiments, recruitment of users may be via the issuer 110, and the latter may put users in touch with the website host computer 202 so that the user may enroll in the vehicle maintenance reminder system 200.

As schematically indicated by arrows 216 in FIG. 2, the mileage tracking/reminder computer system 206 may transmit the maintenance reminders to enrolled users via their user devices 204. However, it need not necessarily be the case that the user device 204 by which enrollment is accomplished via the website host computer 202 be the same device by which the enrolled user receives maintenance reminders from the mileage tracking/reminder computer system 206. In some embodiments, the enrollment data for a given user may specify two or more addresses for addressing the maintenance reminders, and the user may receive the reminders via one or more different user devices 204. In some embodiments, the address information for the maintenance reminders may be a mobile telephone number and/or an email address.

Although only one issuer 112 is shown in FIG. 2, in a practical embodiment of the vehicle maintenance reminder system 200 a considerable number of issuers may be involved in the system. It will further be recognized that data for transactions from numerous merchants may be utilized in the vehicle maintenance reminder system 200. Also, in some embodiments, more than one payment network 110 may be involved.

The system as illustrated in FIG. 2 may be construed to assume that the payment system from which the transaction data is obtained may be of the type in which numerous issuers issue payment accounts under a brand owned by the operator of the payment network 110. However, this need not necessarily be the case—in some embodiments the payment system may have only a single account issuer that is also the operator of the payment network 110.

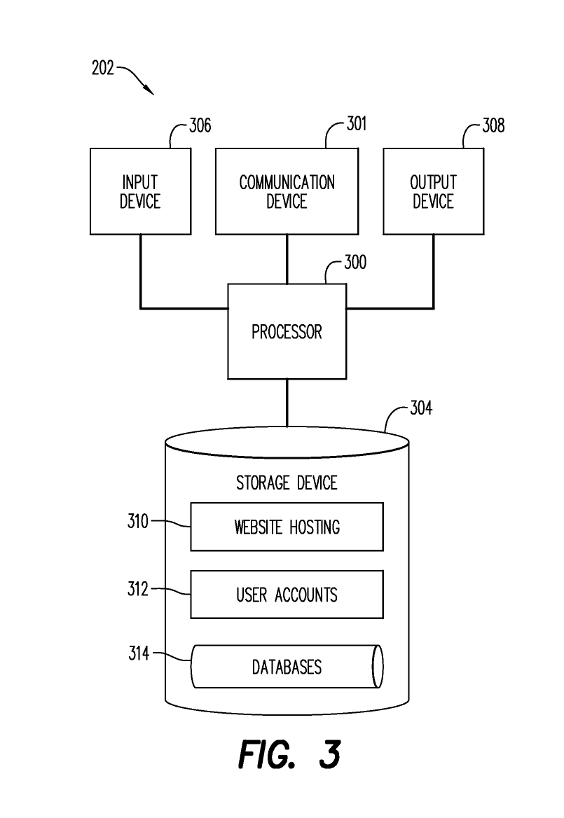

FIG. 3 is a block diagram representation of an embodiment of the website host computer 202, as provided according to aspects of the present disclosure. In some embodiments, in its hardware aspects, the website host computer 202 may be constituted by server computer hardware of a type typically used to host a website accessible via the internet.

The website host computer 202 may include a computer processor 300 operatively coupled to a communication device 301, a storage device 304, an input device 306 and an output device 308.

The computer processor 300 may be constituted by one or more processors. Processor 300 operates to execute processor-executable steps, contained in program instructions described below, so as to control the website host computer 202 to provide desired functionality.

Communication device 301 may be used to facilitate communication with, for example, other devices (such as user devices 204 and/or the mileage tracking/reminder computer system 206). For example, communication device 301 may comprise numerous communication ports (not separately shown), to allow the website host computer 202 to communicate simultaneously with a number of other computers and other devices.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the website host computer 202, executed by the processor 300 to cause the website host computer 202 to function as described herein.

The programs may include one or more conventional operating systems (not shown) that control the processor 300 so as to manage and coordinate activities and sharing of resources in the website host computer 202, and to serve as a host for application programs (described below) that run on the website host computer 202.

The programs stored in the storage device 304 may also include a website hosting application program 310 that enables the website host computer 202 to host the above-referenced website for enrolling prospective users of the vehicle maintenance reminder system 200. In addition, the storage device may include a user account set-up application program 312 that controls the processor 300 to enable the website host computer 202 to enroll users for the vehicle maintenance reminder system 200 and to set up user accounts for those users. Details of various embodiments of the user account set-up application program 312 will be described below.

The storage device 304 may also store, and the website host computer 202 may also execute, other programs, which are not shown. For example, such programs may include communications software and a reporting application. The latter program may respond to requests from system administrators for reports on the activities performed by the website host computer 202. The other programs may also include, e.g., device drivers, etc.

The storage device 304 may also store one or more databases 314 that are required for operation of the website host computer 202.

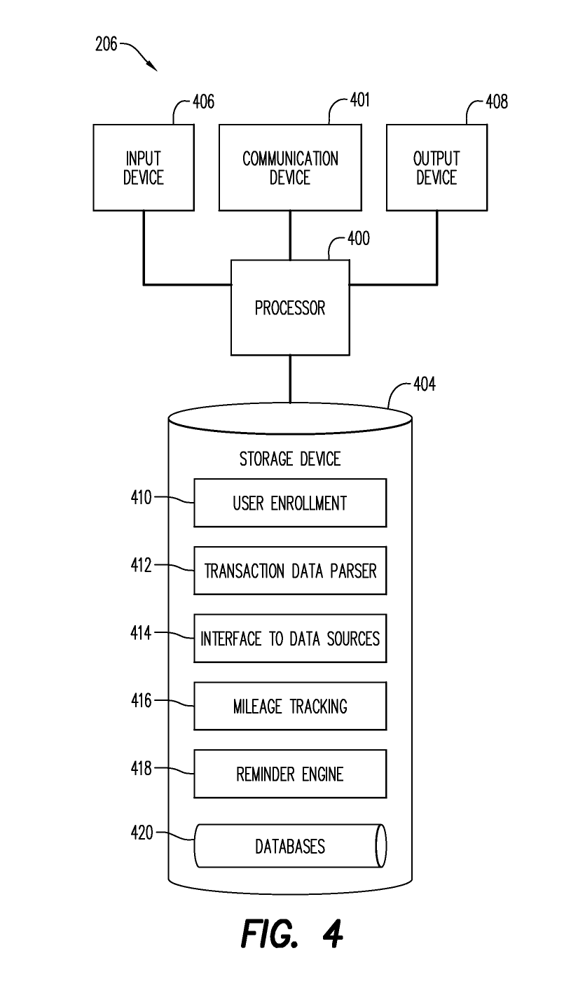

FIG. 4 is a block diagram representation of an embodiment of the mileage tracking/reminder computer system 206 as provided according to aspects of the present disclosure.

The mileage tracking/reminder computer system 206 may have the same hardware architecture as was described above in connection with FIG. 3. For example, the mileage tracking/reminder computer system 206 may be constituted, in hardware terms, as a mainframe computer. Like the embodiment of the website host computer 202 as described above, the mileage tracking/reminder computer system 206 as shown in FIG. 4 may include a computer processor 400, a communication device 401, a storage device 404, an input device 406 and an output device 408. The descriptions of hardware aspects of the like-named components shown in FIG. 3 are also applicable to the components of the mileage tracking/reminder computer system 206 as enumerated in the previous sentence. As was the case with the hardware components depicted in FIG. 3, any one or more of the hardware components shown in FIG. 4 may be in communication with any one or more of the other hardware components shown in FIG. 4.

Storage device 404 stores one or more programs for controlling processor 400. The programs comprise program instructions (which may be referred to as computer readable program code means) that contain processor-executable process steps of the mileage tracking/reminder computer system 206, executed by the processor 400 to cause the mileage tracking/reminder computer system 206 to function as described herein.

The programs may include one or more conventional operating systems (not shown) that control the processor 400 so as to manage and coordinate activities and sharing of resources in the mileage tracking/reminder computer system 206, and to serve as a host for application programs (described below) that run on the mileage tracking/reminder computer system 206.

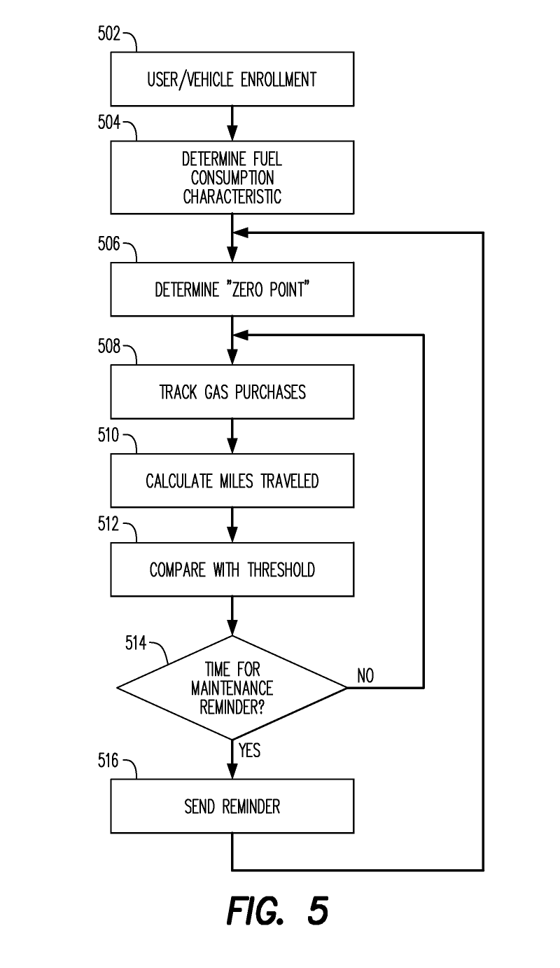

The programs stored in the storage device 404 may also include a user enrollment application program 410. The application program 410 may receive user enrollment data from the website host computer 202 and may generate a respective data partition for each user that has undertaken an enrollment process via the website host computer 202. The data partition may include information regarding the user, such as information described in more detail below in connection with FIG. 5.

The programs stored in the storage device 404 may further include a transaction data parser program 412. The transaction data parser program 412 may enable the mileage tracking/reminder computer system 206 to analyze the transaction data received from the data warehouse 208 and may extract from the data all of the data elements required for the mileage tracking and reminder generation processes described below.

In addition, the storage device 404 may store a program 414 that serves as an interface to the data sources (e.g., components 208, 210 and/or 212 shown in FIG. 2) from which the mileage tracking/reminder computer system 206 obtains the data needed for mileage tracking and other analysis described herein.

Still further, the storage device 404 may store a mileage tracking application program 416. Details of functionality provided by the mileage tracking/reminder computer system 206 via the mileage tracking application program 416 will be described below in connection with FIG. 5.

Moreover, the storage device 404 may store a maintenance reminder engine 418 which enables the mileage tracking/reminder computer system 206 to generate maintenance reminders in accordance with teachings of this disclosure and as described, for example, in connection with FIG. 5.

The storage device 404 may also store, and the mileage tracking/reminder computer system 206 may also execute, other programs, which are not shown. For example, such programs may include communications software, a reporting application, device drivers, etc.

Also, the storage device 404 may store one or more databases 420 that are required for operation of the mileage tracking/reminder computer system 206.

In some embodiments, the hardware making up the mileage tracking/reminder computer system 206 and the website host computer 202 may at least partially overlap. For example, in some embodiments, a single computer or computer system may perform some or all of the functions of both the mileage tracking/reminder computer system 206 and the website host computer 202. In other embodiments, the website host computer 202 and the mileage tracking/reminder computer system 206 may be separate from and even located remotely from each other, although it may often be the case that data communications may take place between the website host computer 202 and the mileage tracking/reminder computer system 206.

FIG. 5 is a flow chart that illustrates aspects of the present disclosure, including functions that may be performed in the mileage tracking/reminder computer system 206.

At 502 in FIG. 5, a user is enrolled in the vehicle maintenance reminder system 200. As suggested by prior discussion, this may take place via the user's interaction with the website host computer 202 via a user device 204. In some embodiments the user may enroll by entering information into the website host computer 202 and/or authorizing the user's account issuer to transfer information concerning the user to the website host computer 202 and/or to the mileage tracking/reminder computer system 206. In some embodiments, the website host computer 202 may transmit to the mileage tracking/reminder computer system 206 the information provided to the website host computer 202 by or on behalf of the user. The mileage tracking/reminder computer system 206 may store the information for the user in a data partition dedicated to the user—and/or in a database of user information—to implement enrollment of the user into the vehicle maintenance reminder system 200.

In some embodiments, the information entered to enroll the user may include the user's name, at least one payment account number for a payment account that belongs to the user, and addressing information (e.g. an email address and/or a mobile telephone number) to be used by the mileage tracking/reminder computer system 206 in sending vehicle maintenance reminders to the user. In some embodiments, the information provided by or on behalf of the user to the vehicle maintenance reminder system 200 may include the make and model (and possibly the model year) of the user's vehicle for which maintenance reminders are to be provided. The enrollment process may also include the user positively indicating (e.g., by virtually checking a box/actuating a button in a web page) that he/she wishes to be enrolled for the service provided by the vehicle maintenance reminder system 200.

At 504 the mileage tracking/reminder computer system 206 may determine a fuel consumption characteristic for the user's motor vehicle. This characteristic may be the typical number of miles traveled by the vehicle per gallon of gasoline (or other fuel) consumed. Thus the fuel consumption characteristic may be an “MPG” figure for the vehicle.

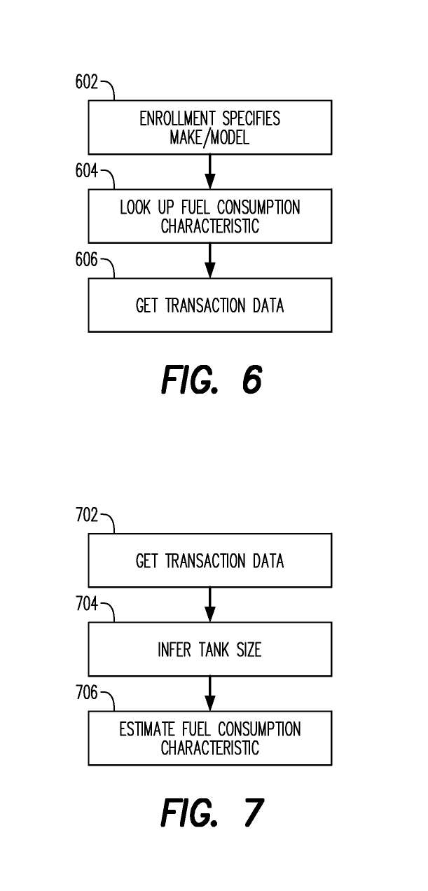

FIG. 6 is a flow chart that illustrates a possible embodiment of the processing undertaken at block 504. At 602 in FIG. 6, the enrollment data provided by the user (or from another source) specifies the make and model (and possibly also model year) for the vehicle for which reminders are to be sent. At 604, the mileage tracking/reminder computer system 206 may look up the standard reported fuel economy figure for the make/model and may adopt that figure as the fuel consumption characteristic for the vehicle to be used in subsequent processing. At 606, the mileage tracking/reminder computer system 206 may obtain relevant payment account transaction data for the vehicle/user. The relevant payment account transaction data may reflect all transactions charged to the user's payment account from relevant merchants—i.e., from merchants such as gas stations and vehicle repair and/or maintenance facilities. The relevant data may be for a particular period of time, say the last twelve months, and/or may be supplied with respect to transactions that occur on an ongoing basis. If ongoing transactions are involved, the data may be supplied in real time or in batches, say weekly.

FIG. 7 is a flow chart that illustrates an alternative possible embodiment of the processing at block 504. At 702 in FIG. 7, the mileage tracking/reminder computer system 206 may obtain relevant payment account transaction data for the vehicle/user. The relevant payment account transaction data may reflect all transactions charged to the user's payment account from relevant merchants—i.e., from merchants such as gas stations and vehicle repair and/or maintenance facilities. The time period(s) covered may be as described in the previous paragraph.

At 704 in FIG. 7, the mileage tracking/reminder computer system 206 may analyze the payment account transaction data obtained at 702 to estimate/infer the size of the gas tank of the vehicle for which reminders are to be issued. This may be done, for example, by inferring the typical number of gallons of gasoline purchased in the transactions represented by the payment account transaction data. The mileage tracking/reminder computer system 206 may, for example, set a threshold of $100.00 and disregard transaction for amounts larger than the threshold. For the remaining transactions, the mileage tracking/reminder computer system 206 may derive a pattern of number of gallons purchased form the dollar amounts of the purchases. The vehicle maintenance reminder system 200 may access past/historical gasoline price information (e.g., from gas price data source 210, FIG. 2) to determine the actual or approximate price per gallon for the region/town(s)/city(ies) and/or specific merchant locations at which the transactions occurred to arrive at a price per gallon figure to be applied to one or more of the dollar amount transactions. With this figure, the mileage tracking/reminder computer system 206 may be able to estimate the number of gallons purchased at each transaction. In estimating the gas tank size, the mileage tracking/reminder computer system 206 may disregard at least some outlier transactions—e.g., the mileage tracking/reminder computer system 206 may disregard particularly low dollar amount transactions, but may take into consideration higher than usual gas purchase amounts. From the inferred pattern of gasoline quantity purchases, the mileage tracking/reminder computer system 206 may estimate the fuel tank size for the vehicle in question. In turn, from the estimated fuel tank size (and as indicated at 706), the mileage tracking/reminder computer system 206 may estimate/infer a fuel consumption characteristic of the vehicle. This may be feasible because there is commonly an inverse correlation between fuel tank sizes for vehicles and their fuel consumption efficiencies relative to miles traveled.

Referring again to FIG. 5, block 506 may follow block 504. At block 506, the mileage tracking/reminder computer system 206 may analyze the payment account transaction data to infer/determine the most recent occasion on which the vehicle in question underwent routine maintenance. In making this determination, the mileage tracking/reminder computer system 206 may filter out transactions deemed to be simply fuel purchases. For example, in some embodiments, the mileage tracking/reminder computer system 206 may set a threshold of say $80 and may filter out all transactions having dollar amounts below that threshold. In some embodiments, the most recent transaction that was not filtered out may be taken as indicating the most recent date on which maintenance was performed on the vehicle (e.g., last oil change). This date may be taken as the “zero point” from which gas purchases will be tracked by the mileage tracking/reminder computer system 206 to determine when a maintenance reminder should be issued. In some embodiments, the mileage tracking/reminder computer system 206 may perform one or more other pattern matching analyses to estimate/infer the “zero point”.

Continuing to refer to FIG. 5, with the “zero point” having been inferred, block 508 may follow. At block 508, the mileage tracking/reminder computer system 206 scans incoming transaction data/analyzes past transaction data to track gasoline purchases by the user. As before, the identity or category of the merchant and the purchase amount (e.g., purchases at the relevant merchant of less than $100) may be used as markers to aid in identifying or inferring that a given transaction is a gasoline purchase. In some embodiments, transactions involving irrelevant merchants may have been filtered out prior to the transaction data reaching the mileage tracking/reminder computer system 206. In some embodiments, the threshold for determining that the transaction is a gasoline purchase may be varied by the mileage tracking/reminder computer system 206 according to the inferred or known gas tank capacity for the user's vehicle. (The gas tank capacity may be “known” from vehicle specification data accessible to the mileage tracking/reminder computer system 206 in cases where the make and model (and possibly model year) for the vehicle were supplied to the mileage tracking/reminder computer system 206.) That is, where the known or inferred tank capacity is low, a lower threshold may be used to “sort in” purchase transactions as likely fuel purchases. Where the known or inferred tank capacity is high, a higher threshold may be used to “sort in” purchase transactions as likely fuel purchases.

At 510, the mileage tracking/reminder computer system 206 may translate the dollar amounts of the apparent fuel purchases into number of gallons purchased. This translation may be based on date and location of purchase, together with gasoline price information, as referred to above. Moreover, using the fuel consumption characteristic of the vehicle (determined/estimated at block 504), the mileage tracking/reminder computer system 206 may further translate the quantity of fuel purchased into number of miles traveled. This figure, in turn, can be added to the previous total of miles traveled that the mileage tracking/reminder computer system 206 has accumulated in its records for the vehicle since the “zero point”. Then, at 512, the mileage tracking/reminder computer system 206 may compare the updated accumulated mileage traveled figure with a threshold. The threshold may be, for example, in the range of 3,000 or more miles to 5,000 or less miles (i.e., an appropriate interval between oil changes or the like).

Based on a result of the comparison at block 512, the mileage tracking/reminder computer system 206 may determine—at decision block 514—whether it is an appropriate time, in view of the cumulative miles traveled since the “zero point”, for the mileage tracking/reminder computer system 206 to send a maintenance reminder to the user/vehicle owner/lessee. That is, if the cumulative mileage traveled estimate is at or exceeds the threshold, a positive determination may be made at decision block 514, in which case block 516 may follow decision block 514. Otherwise, a negative determination may be made at decision block 514, and the process may loop back from decision block 514 to the sequence of blocks 508, 510, 512.

In the case where the process flow reaches block 516, the mileage tracking/reminder computer system 206 may send a suitable vehicle maintenance reminder to the user of the vehicle maintenance reminder system 200. This may be done via email, SMS, etc., and may use, for example, the user's email address and/or mobile telephone number as addressing information for the reminder message. In some embodiments, it may be deemed worthwhile to prompt the user to acknowledge receipt of the message and possibly to repeat sending of the reminder message after a certain period of time if the user does not acknowledge the initial reminder message.

In some embodiments, after block 516 the process of FIG. 5 may loop back to block 506.

In some embodiments, in a processing path not explicitly shown in the drawing, the mileage tracking/reminder computer system 206 may monitor the user's transactions for a possible occurrence of a maintenance transaction while also tracking the vehicle's mileage via fueling transactions. If a maintenance transaction is detected/inferred prior to the time when a reminder is warranted, the mileage tracking/reminder computer system 206 may reset the “zero point” and reset (change to zero) the accumulated mileage figure, thereby returning to blocks 506, 508, etc.

In some embodiments, the vehicle maintenance reminder system 200 may operate in a manner that is relatively interactive with the user. As noted above, in some embodiments the user may be prompted to identify his/her vehicle by make and model and/or to acknowledge receipt of a maintenance reminder notice. In addition, the user may be encouraged in some embodiments to actively report maintenance transactions, e.g., via the website host computer 202. In some embodiments, the vehicle maintenance reminder system 200 may monitor payment account transaction data for the user to confirm the user's report that vehicle maintenance was actually performed.

In some embodiments, other features may facilitate the user's de-enrollment of a vehicle and/or replacement of an old vehicle with a new vehicle in connection with the services provided by the vehicle maintenance reminder system 200.

The vehicle maintenance reminder system 200, as described herein, may have a positive effect in terms of how regularly and promptly users thereof obtain routine maintenance for their motor vehicles. This may improve the efficiency of the vehicles, increase their useful life and/or lower the life-cycle cost of ownership of the vehicles. To the extent that leased vehicles (or their users) are enrolled in the system, the leasing entity's investment in the vehicle may be more fully protected, and the user's maintenance obligations under the vehicle leasing agreements may be performed more fully and reliably.

In some embodiments, the user's payment account issuer may promote participation in the system as a value-added service provided by/through the issuer, and/or as a perk for the account holder/user. In addition or alternatively, enrollment may be promoted and facilitated by “quick lube” companies or the like, to encourage regular use of their services. Another possibility is that a lessor of motor vehicles may mandate that the lessee participate in the system. In the latter case, and in a relatively interactive embodiment of the system, the user may in effect be required to “prove” to the vehicle lessor that he/she has complied with the reminder via an automatic notice from the mileage tracking/reminder computer system 206 to the lessor in which the mileage tracking/reminder computer system 206 reports detection of the maintenance transaction that was supposed to have occurred (i.e., for which the reminder was issued). In addition or alternatively, the lessee/user may be required to report via messaging (e.g., via the website host computer 202 or directly to the vehicle lessor) that the maintenance has occurred, and the existence of corresponding payment account transaction data may be confirmed to the lessor via the mileage tracking/reminder computer system 206.

In some embodiments, the operator of the payment network 110 may play a central role in recruiting and enrolling users, in addition to possibly operating the mileage tracking/reminder computer system 206. In some embodiments, the website host computer 206 may be the same computer through which the account issuer provides electronic banking services to its account holders, and the enrollment of the user may be a relatively simple opt-in exercise in connection of the user's engagement with the issuer's online banking services.

In some embodiments, a single user may enroll two or more vehicles for his/her household, and may aid the vehicle maintenance reminder system 200 in distinguishing between transactions for the different vehicles by supplying information to the vehicle maintenance reminder system 200 to supplement the information that can be inferred from the payment account transaction data. For example, the vehicle maintenance reminder system 200 may query the user when an apparent fueling or maintenance transaction is detected, and the user may respond to the query by specifying which vehicle was fueled or serviced in the particular transaction. For example, the vehicle maintenance reminder system 200 may send to the user a message such as, “You bought $25.00 of gas yesterday at XYZ gas station in Purchase, NY—was it for the Chevy or the Honda?”; the user may respond accordingly to aid the vehicle maintenance reminder system 200 in its mileage tracking processing for both vehicles.

In another aspect of possible interaction between users and the vehicle maintenance reminder system 200, upon enrollment users may enter information about their vehicle fueling habits, possibly by indicating a preference between information input options such as, “I usually refill when the tank is ¼ full” or “I usually wait to refill until the tank is nearly empty”, etc. This may aid the vehicle maintenance reminder system 200 in making some of its estimates/inferences relative to its vehicle mileage tracking setup and or operations with respect to a particular user.

In another type of interaction that may occur between users and the vehicle maintenance reminder system 200, upon enrollment the user may be queried as to what type of driving (i.e., highway versus city) he/she mainly engages in. This may aid the vehicle maintenance reminder system 200 in determining whether to use an official highway mileage figure or an official overall mileage figure as the fuel consumption characteristic for the vehicle.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles payment card transactions. The term “payment card” includes a credit card, debit card, prepaid card, or other type of payment instrument, whether an actual physical card, electronic, or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
analyzing payment account transaction data relevant to a motor vehicle;
based on at least one result of said analyzing, estimating a number of miles traveled by the motor vehicle since a vehicle maintenance transaction involving the motor vehicle; and
based on at least one result of said estimating, providing a notification to a user of the motor vehicle concerning a need to obtain maintenance for the motor vehicle.

2. The method of claim 1, wherein the payment account transaction data represents transactions charged to a payment account that belongs to the user of the motor vehicle.

3. The method of claim 1, wherein the estimating step includes estimating a fuel tank capacity of the motor vehicle.

4. The method of claim 3, wherein the estimating step includes estimating an average fuel consumption characteristic of the motor vehicle.

5. The method of claim 4, wherein the estimating step includes estimating a price per gallon paid to obtain fuel for the motor vehicle.

6. The method of claim 1, further comprising:
receiving data indicative of a make and model of the motor vehicle; and
wherein the estimating step is based in part on a reported standard average fuel consumption characteristic of said make and model.

7. The method of claim 1, wherein said analyzing step includes inferring that certain transactions represented by the payment account transaction data were payments for obtaining fuel for the motor vehicle.

8. The method of claim 7, wherein said analyzing step includes inferring that one of the transactions represented by the payment account transaction data was said vehicle maintenance transaction.

9. The method of claim 1, wherein said inference regarding said vehicle maintenance transaction is based at least in part on a monetary amount indicated in corresponding payment account transaction data.

10. The method of claim 9, wherein said inference regarding said vehicle maintenance transaction is based at least in part on an identity or type of merchant indicated in corresponding payment account transaction data.

11. The method of claim 7, wherein said inferences regarding said fuel payment transactions are based at least in part on monetary amounts indicated in corresponding payment account transaction data.

12. The method of claim 11, wherein said inferences regarding said fuel payment transactions were based at least in part on identities or types of merchants indicated in corresponding payment account transaction data.

13. A method comprising:
inferring, from first payment account transaction data, a point in time at which maintenance was performed on a motor vehicle;
estimating a quantity of gasoline purchased to fuel the motor vehicle, during a period commencing with said point in time and based on second payment account transaction data that is subsequent to the first payment account transaction data;
estimating a fuel consumption characteristic of the motor vehicle based on third payment account transaction data that may include said second payment account transaction data;
calculating an estimated miles traveled figure for the motor vehicle based on the estimated quantity of gasoline purchased and the estimated fuel consumption characteristic;
comparing the estimated miles traveled figure with a threshold, and
based on a result of the comparing step, issuing a notification to a user of the motor vehicle that the motor vehicle is due for maintenance.

14. The method of claim 13, wherein said third payment account transaction data includes data that precedes said first payment account transaction data.

15. The method of claim 13, wherein the threshold is selected to fall in a range having a first endpoint of 3,000 miles and a second endpoint of 5,000 miles, said endpoints included in said range.

16. A method comprising:
receiving an indication from a user that the user wishes to enroll a motor vehicle in a maintenance reminder program;
tracking purchases of fuel for the motor vehicle via payment account transactions;
using the payment account transactions to estimate a number of miles traveled by the motor vehicle; and
issuing at least one maintenance reminder based on the estimated number of miles traveled.

17. The method of claim 16, wherein the indication includes data indicative of a make and model of the motor vehicle.

18. The method of claim 17, further comprising:
looking up a fuel consumption characteristic of the make and model.

19. The method of claim 18, wherein the estimate of the number of miles traveled is based in part on the looked-up fuel consumption characteristic.

20. The method of claim 19, wherein the estimate of the number of miles traveled is based in part on estimated gasoline costs reflected in the payment account transactions.
